(19) United States
(12) Patent Application Publication
(10) Pub. No.: US 2026/0238305 A1
(43) Pub. Date: Aug. 13, 2026

(54) METHOD FOR BEAM REPORT TO FACILITATE MULTIUSER MIMO

(71) Applicant: Google LLC, Mountain View, CA (US)

(72) Inventors: Yushu ZHANG, Beijing (CN); Jia-Hong LIOU, Taipei City (CN)

(21) Appl. No.: 19/156,073

(22) PCT Filed: Feb. 17, 2023
(86) PCT No.: PCT/CN2023/076936

§ 371 Date: Aug. 13, 2025

(51) Int. Cl. H04B 7/06; H04B 17/318

(52) U.S. Cl. CPC H04B 7/06952; H04B 7/0626; H04B 17/328

(57) ABSTRACT

This disclosure provides systems, devices, apparatus, and methods, including computer programs encoded on storage media, for beam measurement and report procedure. A user equipment receives, from a network entity, reference signals transmitted on one or more network beams. The UE transmits, to the network entity, a report indicating a first beam that satisfies a beam pairing criteria for co-scheduling, the first beam being reported based on a measurement of the reference signals transmitted on the one or more network beams.

### TECHNICAL FIELD

The present disclosure relates generally to wireless communication, and more particularly, to beam reporting.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, co-scheduling user equipments (UEs) for multiple input multiple output (MU-MIMO) may present a mutual interference between the UEs.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity, such as a base station or a unit of a base station, can transmit multiple downlink reference signals to a user equipment (UE). The multiple downlink reference signals may include synchronization signal blocks (SSBs) and/or channel state information-reference signals (CSI-RSs) that are transmitted with different network beams. The UE measures a quality of each network beam based on a layer 1 reference signal received power (L1-RSRP) or a layer 1 signal-to-noise and interference plus noise (L1-SINR) of the SSBs or CSI-RSs and reports the beam quality to the network entity. The beam report assists the network entity with selecting a beam for communicating with the UE. The beam report may indicate the best N network beams according to the L1-RSRP/L1-SINR measured by the UE and may improve performance of single-user multiple-input and multiple-output (SU-MIMO) operations. To increase spectral efficiency, the network entity may schedule downlink transmissions to multiple UEs, or uplink reception from multiple UEs, at same time-frequency resources based on different network beams in a multi-user multiple-input and multiple-output (MU-MIMO) operation. MU-MIMO operations may be improved by reducing intra-cell interference. Hence, the network entity may determine to select a network beam to transmit a downlink signal to the UE, or receive an uplink signal from the UE, such that interference to other co-scheduling with the network entity is reduced. For example, the network entity selects a network beam to communicate with the UE that the other co-scheduling UE considers to be a “weak” network beam.

Aspects of the present disclosure address the above-noted and other deficiencies by implementing a beam measurement and report procedure for UEs in communication with the network entity to report, to the network entity, which network beams each UE considers to be weak network beams. In a first example, the UE may transmit, to the network entity, an independent beam measurement report that indicates the weak beam information to the network entity in a designated report. In a second example, the UE transmits, to the network entity, a beam measurement report that includes “strong” beam information, but with an enhancement to the beam measurement report that also indicates the weak beam information. The report may be referred to herein as joint beam measurement report. Both independent beam measurement reports (e.g., with weak beam information) and joint beam measurement reports (e.g., with both strong and weak beam information) may provide improved performance for MU-MIMO operations.

According to some aspects, a user equipment (UE) receives, from a network entity, reference signals transmitted on one or more network beams. The UE transmits, to the network entity, a report indicating a first beam that satisfies a beam pairing criteria for co-scheduling, the first beam being reported based on a measurement of the reference signals transmitted on the one or more network beams.

According to some aspects, a network entity transmits, to a user equipment (UE), control signaling that configures a report based on beam pairing criteria for a co-scheduling, the control signaling indicating configured resources for reference signals. The network entity transmits, to the UE, the reference signals on one or more network beams. The network entity receives, from the UE, a report indicating a first beam that satisfies the beam pairing criteria for the co-scheduling, the first beam being reported based on a measurement of the reference signals.

### BRIEF DESCRIPTION OF THE DRAWINGS

FIG. 1 illustrates a diagram of a wireless communications system that includes a plurality of user equipments (UEs) and network entities in communication over one or more cells.

FIGS. 2-3 illustrates a diagram of multi-user multiple-input multiple-output (MU-MIMO) operation.

FIG. 4 illustrates a signaling diagram of an example scenario in which UE and network entity exchanges messages and implement procedures for performing beam measurement and report procedure, according to some embodiments.

FIG. 5 illustrates a signaling diagram of an example scenario in which UE and network entity exchanges messages and implement procedures for performing beam measurement and report procedure, according to some embodiments.

FIG. 6 illustrates a signaling diagram of an example scenario in which UE and network entity exchanges messages and implement procedures for performing beam measurement and report procedure, according to some embodiments.

FIG. 7 illustrates a signaling diagram of an example scenario in which UE and network entity exchanges messages and implement procedures for performing beam measurement and report procedure, according to some embodiments.

FIG. 8 is a flowchart of a method of wireless communication at a user equipment.

FIG. 9 is a flowchart of a method of wireless communication at a network entity.

FIG. 10 illustrates an example for the beam report for co-scheduling UE pairing based on the configured SSB/CSI-RS resources.

FIG. 11 illustrates an example for the predicted beam report for co-scheduling UE pairing based on the configured SSB/CSI-RS resources.

FIG. 12 illustrates an example for the two sets of beam report for co-scheduling UE pairing and beam selection based on the configured SSB/CSI-RS resources.

FIG. 13 illustrates an example for the two sets of predicted beam report for co-scheduling UE pairing and beam selection based on the configured SSB/CSI-RS resources.

FIG. 14 illustrates an example for the first set of predicted beam report for co-scheduling UE pairing and the second set of beam report for beam selection based on the configured SSB/CSI-RS resources.

FIG. 15 is a flowchart of a method of wireless communication at a user equipment.

FIG. 16 is a flowchart of a method of wireless communication at a network entity.

FIG. 17 is a diagram illustrating a hardware implementation for an example UE apparatus.

FIG. 18 is a diagram illustrating a hardware implementation for one or more example network entities.

### DETAILED DESCRIPTION

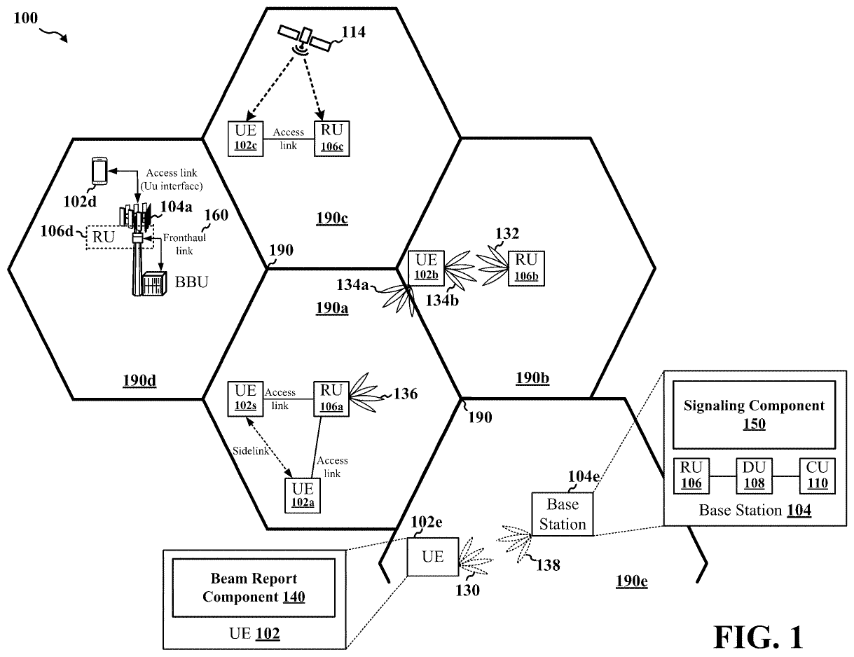

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes.

The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104a/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHZ-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz 300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHZ, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a beam report component 140 configured to receive, from a network entity, reference signals transmitted on one or more network beams; and transmit to the network entity, a report indicating a first beam that satisfies a beam pairing criteria for co-scheduling, the first beam being reported based on a measurement of the reference signals transmitted on the one or more network beams.

In certain aspects, any of the base stations 104 or a network entity of the base stations 104 may include a signaling component 150 configured to transmit, to a user equipment 102, control signaling that configures a report based on beam pairing criteria for a co-scheduling, the control signaling indicating configured resources for reference signals; transmit, to the UE 102, the reference signals on one or more network beams; and receiving, from the UE 102, a report indicating a first beam that satisfies the beam pairing criteria for the co-scheduling, the first beam being reported based on a measurement of the reference signals.

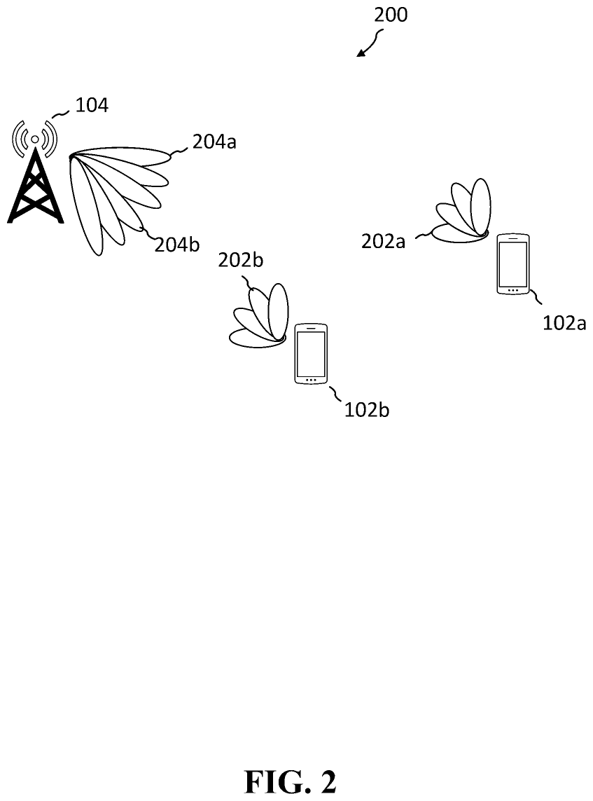

Accordingly, FIG. 1 describes a wireless communication system that may be implemented in connection with aspects of one or more other figures described herein, such as aspects illustrated in FIGS. 2-18. Further, although the following description may be focused on 5G NR, the concepts described herein may be applicable to other similar areas, such as 5G-Advanced and future versions, LTE, LTE-advanced (LTE-A), and other wireless technologies, such as 6G.

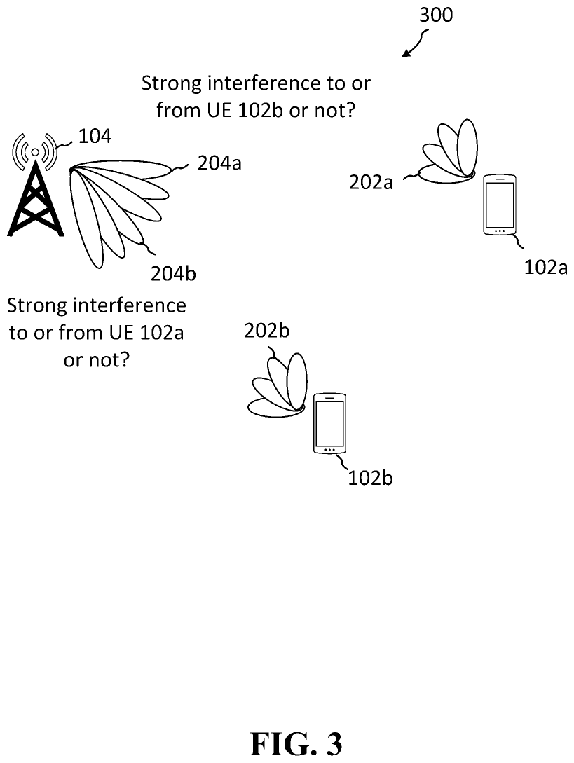

FIGS. 2-3 illustrates a diagram 200, 300 of a multi-user multiple-input multiple-output (MU-MIMO) operation with different network beams. The diagram 200, 300 includes a network entity 104 and a UE 102a and a UE 102b. The network entity 104 can schedule a downlink (DL) transmission to both UEs 102a, 102b simultaneously with different network beams 204a and 204b, respectively. The network entity 104 can also schedule an uplink (UL) reception from more than one UEs (e.g., 102a, 102b) at the same time and on the frequency domain resource using different network beams (e.g., 204a, 204b). In this manner, spectrum efficiency may be improved.

For a DL MU-MIMO, the receiving signal at subcarrier k in UE j can be calculated as follows:

$${Y}_{k} = {W}_{u , k}^{( j )} {H}_{k}^{( j , i )} {W}_{n , k}^{( {i}_{j} )} {P}_{k}^{( {i}_{j} )} {X}_{k}^{( {i}_{j} )} + {\sum }_{m ∈ S and m \neq j} {W}_{u , k}^{( m )} {H}_{k}^{( m , i )} {W}_{n , k}^{( {i}_{m} )} {P}_{k}^{( {i}_{m} )} {X}_{k}^{( {i}_{m} )} + {I}_{k} + {N}_{k}$$

where

$${W}_{u , k}^{( j )}$$

is an analog beam at a UE j to communicate with a network entity;

$${H}_{k}^{( j , i )}$$

is a channel at a subcarrier k between the UE j and the network entity;

$${W}_{n , k}^{( {i}_{j} )}$$

is the analog beam in the network entity to communicate with the UE j;

$${P}_{k}^{( {i}_{j} )}$$

is a digital precoder at the subcarrier k for UE j;

$${X}_{k}^{( {i}_{j} )}$$

is a modulated symbol at the subcarrier k for the UE j; S indicates a set of co-scheduled UEs for a MU-MIMO; Iₖ is an inter-cell interference; Nₖ is the white noise.

For an UL MU-MIMO, the receiving signal in an antenna panel of a network entity to receive a signal from the UE j at the subcarrier k can be calculated as follows:

$${Y}_{k} = {W}_{n , k}^{( {i}_{j} )} {H}_{k}^{( i , j )} {W}_{u , k}^{( j )} {P}_{k}^{( j )} {X}_{k}^{( j )} + {\sum }_{m ∈ S and m \neq j} {W}_{n , k}^{( {i}_{j} )} {H}_{k}^{( i , m )} {W}_{u , k}^{( m )} {P}_{k}^{( m )} {X}_{k}^{( m )} + {I}_{k} + {N}_{k}$$

To facilitate the MU-MIMO operation, one key aspect is to reduce the intra-cell interference, which is to reduce the energy from

$${\sum }_{m ∈ S and m \neq j} {W}_{u , k}^{( m )} {H}_{k}^{( m , i )} {W}_{n , k}^{( {i}_{m} )} {P}_{k}^{( {i}_{m} )} {X}_{k}^{( {i}_{m} )} for DL ,$$

$${\sum }_{m ∈ S and m \neq j} {W}_{n , k}^{( {i}_{j} )} {H}_{k}^{( i , m )} {W}_{u , k}^{( m )} {P}_{k}^{( m )} {X}_{k}^{( m )} for UL .$$

The network entity 104 selects a network beam to transmit the DL signal or receive the UL signal for a UE 102 that produces less interference relative other co-scheduled UEs. The selected network beam may be referred to a “weak” network beam for other co-scheduled UEs.

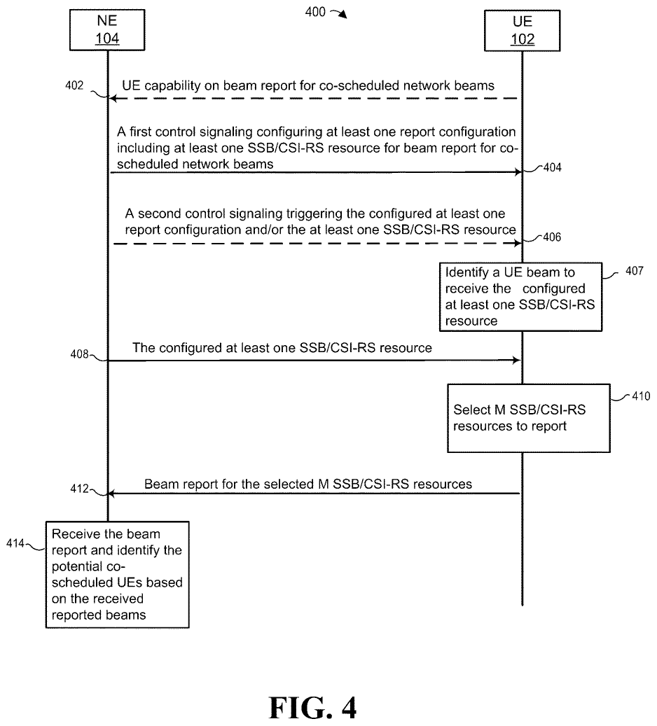

FIG. 3 illustrates examples of how the network entity 104 identifies a weak network beam. The network entity 104 co-schedules the UE 102a and UE 102b using different network beams 204a and 204b, respectively. For example, the scheduled DL signals may be transmitted on the same time-frequency resources but with different network beams 204a and 204b. Also, the scheduled UL signals may be received on the same time-frequency resources but with different network beams 204a and 204b. The network entity 104 may identify and select the network beams 204a, 204b in such a manner as to reduce the mutual interference for the co-scheduled UEs 102a, 102b. That is, the network entity 104 selects network beam 204a to transmit DL signal or receive UL signal with UE 102a (UE beam 202a) that produces less interference relative to UE 102b, and selects network beam 204b to transmit DL signal or receive UL signal with UE 102b (UE beam 202b) that produces less interference relative to UE 102a. The identification and selection of the network beams for co-scheduling UE. Although FIG. 3 shows two UEs for co-scheduling it is understood that more than 2 UE may be co-scheduled based on various aspects describe in detail below. Thus, FIG. 4 illustrates a signaling diagram of an example scenario in which user equipment (UE) and network entity exchanges messages and implement procedures for performing beam measurement and report procedure to address these technical concerns.

FIG. 4 illustrates a signaling diagram 400 of an example scenario in which UE 102 and network entity 104 exchanges messages and implement procedures for performing beam measurement and report procedure to facilitate MU-MIMO co-scheduling, according to some embodiments. The network entity 104 may correspond to the base station or an entity at the base station, such as the RU 106, the DU 108, the CU 110, etc.

In some examples, initially, the UE 102 may transmit 402, to the network entity 104, a UE capability report for supporting a beam report for co-scheduling. Based on the UE capability, the network entity 104 transmits 404 a first control signaling, e.g., RRC signaling (RRCReconfiguration), configuring at least one report configuration, e.g., CSI-ReportConfig, associated with at least one synchronization signal block (SSB)/channel state information reference signal (CSI-RS) resource for beam measurement and indicating the report configuration is used for co-scheduling. Note that SSB/CSI-RS resource(s) means SSB resource(s) or CSI-RS resource(s), and SSB/CSI-RS means SSB or CSI-RS. SSB resource(s) may be defined as time-frequency resources for SSB transmission. CSI-RS resource(s) may be defined as time-frequency resources for CSI-RS transmission.

For a certain type of beam report, e.g., semi-persistent or aperiodic beam report, and/or a certain type of CSI-RS, e.g., semi-persistent or aperiodic CSI-RS, the network entity may transmit a second control signaling, e.g., a medium access control-control element (MAC CE) or a downlink control indicator (DCI), triggering the configured report and/or the configured CSI-RS resource(s).

In this disclosure, unless otherwise specified, a RRC signaling may indicate an RRC reconfiguration message from the network entity 104 to the UE 102, or a System Information Block (SIB), where the SIB can be an existing SIB (e.g., SIB1) or a new SIB (e.g., SIB J, where J is an integer above 21) transmitted by network entity. In addition, the network entity 104 may obtain the UE capability via UE capability report signaling or from another network entity 104 or a core network (e.g., Access and Mobility Management Function (AMF)).

In some embodiments, the UE 102 transmits 402 the UE capability on beam report for co-scheduling UE pairing indicating at least one of the elements: whether the UE 102 supports beam report for co-scheduling user pairing; the maximum number of configured SSB/CSI-RS resources for beam report for co-scheduling UE pairing per bandwidth part (BWP), per component carrier (CC), per band, per band combination and/or across all the bands; the maximum number of SSB/CSI-RS resources for beam report for co-scheduling UE pairing in a slot per BWP, per CC per band, per band combination and/or across all the bands; the maximum number of reported SSB/CSI-RS resources or beams for beam report for co-scheduling UE pairing; the minimum number of SSB/CSI-RS resources for beam prediction for co-scheduling UE pairing. The UE 102 may report the UE capability per feature set, per band, per band combination, or across all the bands.

In some implementations, for inter-cell multi-TRP operation or layer 1/layer 2 centric inter-cell mobility, the UE 102 may report separate UE capability described above for multiple cells. In one example, the UE may report a UE capability indicating the maximum number of SSB/CSI-RS resources in a slot associated with the physical serving cell and another UE capability indicating the maximum number of SSB/CSI-RS resources in a slot associated with cell(s) other than the physical serving cell.

The network entity 104 may transmit 406, to the UE 102, a second control signaling triggering the at least one report configuration and/or the at least one SSB/CSI-RS resource.

The UE 102 identifies 407 a UE beam to receive the configured at least one SSB/CSI-RS resource.

Then, the network entity 104 transmits 408, to the UE 102, the at least one SSB/CSI-RS resource. For example, the network entity 104 transmits SSB/CSI-RS on the configured at least one SSB/CSI-RS resource.

The UE 102 measures a beam quality based on the configured SSB/CSI-RS resource(s). The UE 102 selects 410 M SSB/CSI-RS resources to report. That is, the UE 102 measures a beam quality based on the SSB/CSI-RS transmitted on the configured SSB/CSI-RS resource(s). M may be predefined or configured by RRC.

The UE 102 transmits a beam report for the selected M SSB/CSI-RS resources. For example, the UE 102 transmits 412, to the network entity 104, a beam report that may include indicators SSB resource indicator/CSI resource indicator (SSBRI/CRI) indicating the beams that can satisfy the beam pairing criteria for co-scheduling. The UE 102 may transmit the beam report via a physical uplink control channel (PUCCH) or a physical uplink shared channel (PUSCH). Alternatively, the UE 102 may transmit the beam report via a MAC-CE.

The network entity 104 receives 414, from the UE 102, the beam report and identifies the potential co-scheduling UEs pair (e.g., UE 102a and 102b in FIG. 3) based on the reported beams.

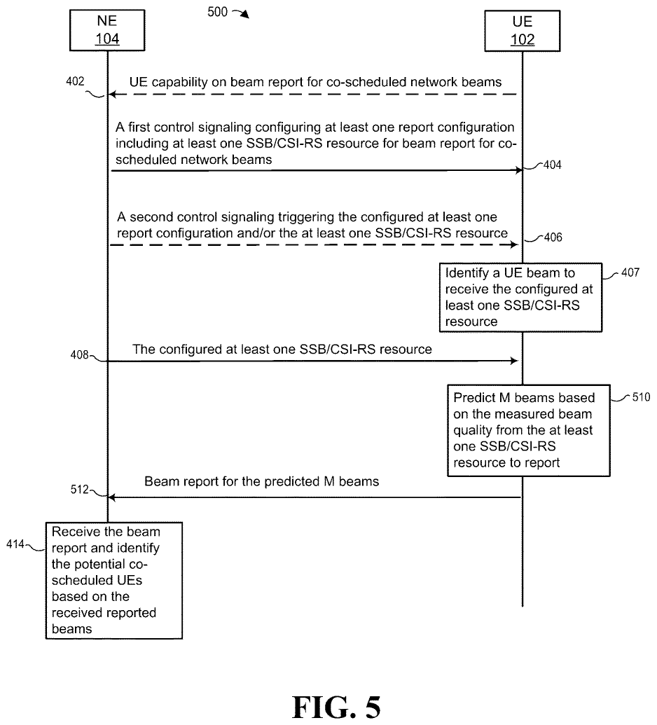

FIG. 4 describes a signaling diagram of an example scenario in which a UE and a network entity exchange messages and implement procedures for performing beam measurement and report procedure, and FIG. 5 describes a signaling diagram of another example scenario in which a UE and a network entity exchange messages and implement procedures for performing beam measurement and report procedure.

FIG. 5 illustrates a signaling diagram 500 of another example scenario in which a user equipment (UE) and a network entity exchange messages and implement procedures for performing beam measurement and report procedure. The diagram 500 of FIG. 5 is similar to the diagram 400 of FIG. 4 except for the following description below. Accordingly, the messages and procedures that have the same reference number will not be described again for the sake of brevity.

The UE 102 predicts 510 M beams based on the measured beam quality from the at least one SSB/CSI-RS resource to report. In one example, the UE 102 may perform the prediction based on machine learning.

The UE 102 transmits 512, to the network entity 104, beam report for the predicted beams.

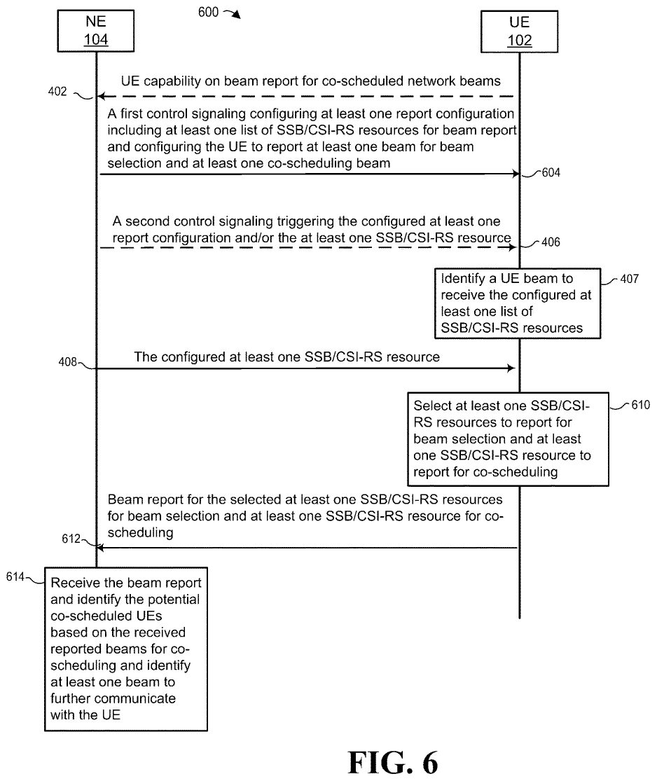

The network entity 104 receives 414, from the UE 102, the beam report and identifies the potential co-scheduling UEs pair based on the reported beams. FIG. 5 describes a signaling diagram of an example scenario in which a UE and a network entity exchange messages and implement procedures for performing beam measurement and report procedure, and FIG. 6 describes a signaling diagram of another example scenario in which a UE and a network entity exchange messages and implement procedures for performing beam measurement and report procedure.

FIG. 6 illustrates a signaling diagram 600 of another example scenario in which a user equipment (UE) and a network entity exchange messages and implement procedures for performing beam measurement and report procedure. The diagram 600 of FIG. 6 is similar to the diagram 400 of FIG. 4 except for the following description below. Accordingly, the messages and procedures that have the same reference number will not be described again for the sake of brevity.

Referring to FIG. 6, the network entity 104 transmits 604 a first control signaling, e.g., RRC signaling (RRCReconfiguration), configuring at least one report configuration, e.g., CSI-ReportConfig, including at least one list of SSB/CSI-RS resources for beam report and configuring the UE to report at least one beam for beam selection and at least one co-scheduling beam. The network entity 104 configures the UE 102 to report two sets of beams based on the configured at least one list of SSB/CSI-RS resources in beam report(s), where the first set of beam(s) is used for beam selection and the second set of beam(s) is used for co-scheduling UE identification. For example, a report for beam selection may identify the “strong” beams from the network entity whereas the a report for co-scheduling may identify the “weak” beams from the network entity. The “strong” and “weak” beams may be based on measurements of the SSB/CSI-RS transmitted on the configured SSB/CSI-RS resource(s).

The UE 102 identifies 407 a UE beam to receive the configured SSB/CSI-RS resource(s). The UE 102 selects 610 at least one SSB/CSI-RS resources to report for beam selection and at least one SSB/CSI-RS resource to report for co-scheduling.

The UE 102 transmits 612, to the network entity 104, a beam report for the selected at least one SSB/CSI-RS resources for beam selection and at least one SSB/CSI-RS resource for co-scheduling.

The network entity 104 receives 614 the beam report and identifies the potential co-scheduled UEs based on the received reported beams for co-scheduling and identify at least one beam to further communicate with the UE.

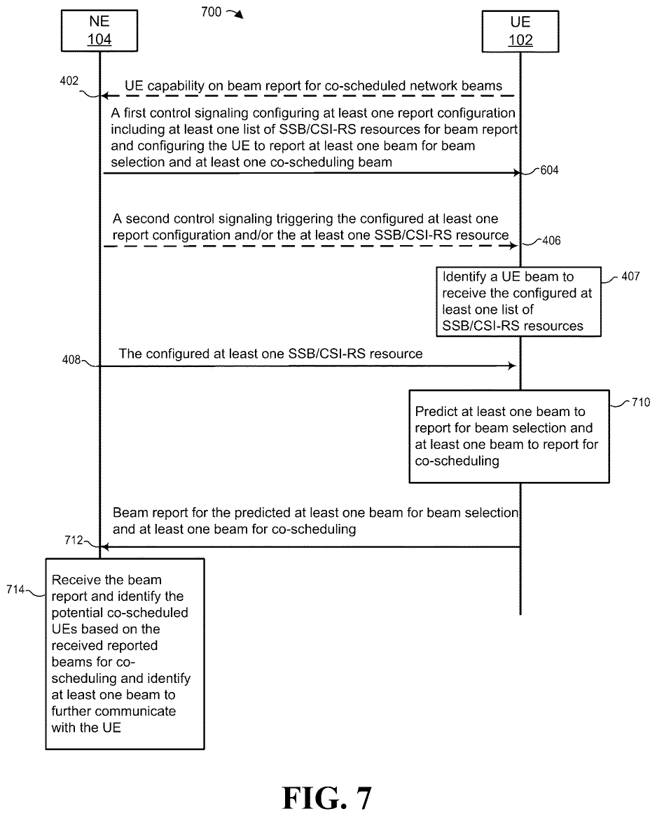

FIG. 6 describes a signaling diagram of an example scenario in which a UE and a network entity exchange messages and implement procedures for performing beam measurement and report procedure, and FIG. 7 describes a signaling diagram of another example scenario in which a UE and a network entity exchange messages and implement procedures for performing beam measurement and report procedure.

FIG. 7 illustrates a signaling diagram 700 of another example scenario in which a user equipment (UE) and a network entity exchange messages and implement procedures for performing beam measurement and report procedure. The diagram 700 of FIG. 7 is similar to the diagram 600 of FIG. 6 except for the following description below. Accordingly, the messages and procedures that have the same reference number will not be described again for the sake of brevity.

The UE 102 identifies 407 a UE beam to receive the configured SSB/CSI-RS resource(s). The UE 102 predicts 710 at least one beam to report for beam selection and at least one beam to report for co-scheduling. In one example, the UE 102 may perform the prediction based on machine learning. The UE 102 can predict two sets of beams based on the configured at least one list of SSB/CSI-RS resources, where the first set of beam(s) is used for beam selection and the second set of beam(s) is used for co-scheduling UE identification.

The UE 102 transmits 712, to the network entity 104, a report for the predicted at least one beam for beam selection and at least one beam for co-scheduling. The beam report includes information corresponding to the two sets of beams, e.g., beam indexes for the beams or beam indexes for the beams and the corresponding beam quality, e.g., a layer 1 reference signal received power (L1-RSRP) and a layer 1 signal-to-noise and interference ratio (L1-SINR).

The network entity 104 receives 714 the beam report and identifies the potential co-scheduled UEs based on the received reported beams for co-scheduling and identify at least one beam to further communicate with the UE.

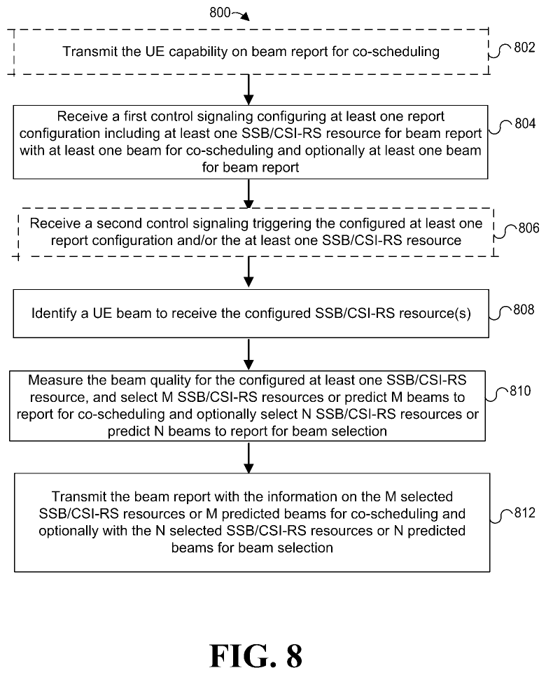

FIG. 7 describes a signaling diagram of an example scenario in which a UE and network entity exchange messages and implement procedures for performing beam measurement and report procedure, whereas FIG. 8 describes a method of performing beam measurement and report procedure from a UE-side of the wireless communication link.

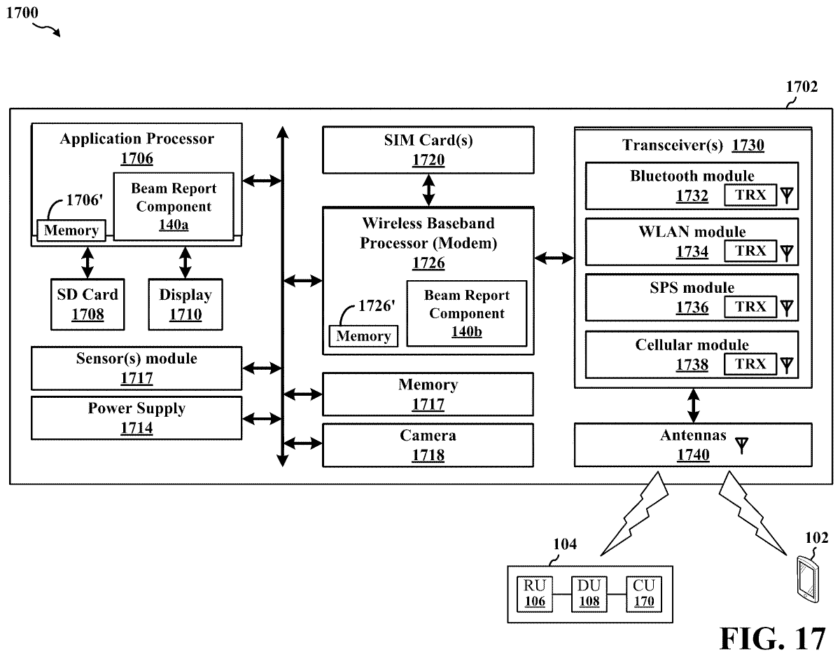

Now turning to FIG. 8 which illustrates an example method 800 for performing beam measurement and report procedure implemented in the UE. The method 800 can be implemented by UE 102 depicted in FIGS. 1-3. With reference to FIGS. 1 and 17, the method 800 may be performed by the UE 102, the UE apparatus 1700, etc., which may include the memory 1724′ and which may correspond to the entire UE 102 or the UE apparatus 1700, or a component of the UE 102 or the UE apparatus 1700, such as the wireless baseband processor 1724, and/or the application processor 1706.

The UE 102 transmits 802, to a network entity 104, a UE capability report indicating a capability of a UE on beam report for co-scheduling. For example, referring to FIGS. 4-7, the UE 102 may transmit 402, to the network entity 104, a UE capability report for supporting a beam report for co-scheduled network beams.

The UE 102 receives 804, from the network entity 104, a first control signaling configuring at least one report configuration including at least one SSB/CSI-RS resource for beam report with at least one beam for co-scheduling and configuring at least one beam for the beam report. For example, referring to FIGS. 4-7, the UE 102 receives 404, from the network entity 104, a first control signaling, e.g., RRC signaling (RRCReconfiguration), configuring at least one report configuration, e.g., CSI-ReportConfig, associated with at least one synchronization signal block (SSB)/channel state information reference signal (CSI-RS) resource for beam measurement and indicating the report configuration is used for co-scheduled network beam selection.

The UE 102 receives 806 a second control signaling triggering the configured at least one report configuration and/or the at least one SSB/CSI-RS resource. For example, referring to FIGS. 4-7, the UE 102 may receive 406, from the network entity 104, a second control signaling triggering the at least one report configuration and/or the at least one SSB/CSI-RS resource.

The UE 102 identifies 808 a UE beam to receive the configured SSB/CSI-RS resources. For example, referring to FIGS. 4-7, the UE 102 identifies 407 a UE beam to receive the configured at least one SSB/CSI-RS resource.

The UE 102 measures 810 the beam quality for the configured at least one SSB/CSI-RS resource. In some implementations, the UE 102 selects 810 M SSB/CSI-RS resources or predict M beams to report for co-scheduling. In other implementations, the UE 102 selects N SSB/CSI-RS resources or predict N beams to report for beam selection. For example, referring to FIGS. 4-7, the UE 102 measures 410 a beam quality based on the configured SSB/CSI-RS resource(s). The UE 102 selects 410 M SSB/CSI-RS resources to report.

The UE 102 transmits 812 the beam report with the information on the M selected SSB/CSI-RS resources or M predicted beams for co-scheduling and optionally with the N selected SSB/CSI-RS resources or N predicted beams for beam selection. For example, referring to FIG. 4, the UE 102 transmits 412, to the network entity 104, indicators (SSBRI/CRI) indicating the beams that can satisfy the co-scheduling criteria. The UE 102 may transmit the beam report via a physical uplink control channel (PUCCH) or a physical uplink shared channel PUSCH. Alternatively, the UE 102 may transmit the beam report via a MAC-CE.

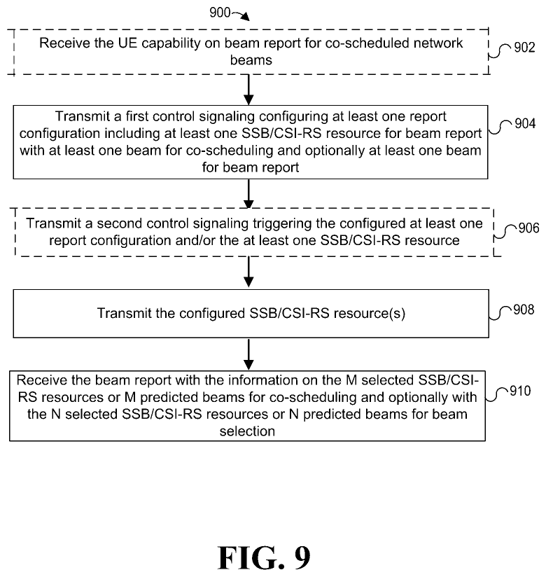

FIG. 8 describes a method from a UE-side of a wireless communication link, whereas FIG. 9 describes a method from a network-side of the wireless communication link.

FIG. 9 is a flowchart 900 of a method of wireless communication at a network entity. With reference to FIGS. 1-7 and 18, the method may be performed by one or more network entities 104, which may correspond to a base station or a unit of the base station, such as the RU 106, the DU 108, the CU 110, an RU processor 1806, a DU processor 1826, a CU processor 1846, etc. The one or more network entities 104 may include memory 1806′/1826′/1846′, which may correspond to an entirety of the one or more network entities 104, or a component of the one or more network entities 104, such as the RU processor 1806, the DU processor 1826, or the CU processor 1846.

The network entity 104 receives 902, from the UE 102, a UE capability report indicating a capability of a UE on beam report for co-scheduling. For example, referring to FIGS. 4-7, network entity 104 receives 402, from the UE 102, a UE capability report for supporting a beam report for co-scheduled network beams.

The network entity 104, transmits 904, to the UE 102, a first control signaling configuring at least one report configuration including at least one SSB/CSI-RS resource for beam report with at least one beam for co-scheduling and optionally at least one beam for beam report. For example, referring to FIG. 4, the network entity transmits 404, to the UE 102, a first control signaling, e.g., RRC signaling (RRCReconfiguration), configuring at least one report configuration, e.g., CSI-ReportConfig, associated with at least one SSB/CSI-RS resource for beam measurement and indicating the report configuration is used for co-scheduled network beam selection.

The network entity 104 transmits 906, to the UE 102, a second control signaling triggering the configured at least one report configuration and/or the at least one SSB/CSI-RS resource. For example, referring to FIG. 4, the network entity 104 transmits 406, to the UE 102, a second control signaling triggering the at least one report configuration and/or the at least one SSB/CSI-RS resource.

The network entity 104 transmits 908, to the UE 102, the SSB/CSI-RS the configured SSB/CSI-RS resource(s). For example, referring to FIG. 4, the network entity 104 transmits 408, to the UE 102, the at least one SSB/CSI-RS resource.

The network entity 104 receives 910 the beam report with the information on the M selected SSB/CSI-RS resources or M predicted beams for co-scheduling and optionally with the N selected SSB/CSI-RS resources or N predicted beams for beam selection. For example, the network entity 104 receives 412, from the UE 102, a report of the predicted beam information for co-scheduling.

In an embodiment, the network entity 104 transmits the first or the second control signaling configuring a reference SSB/CSI-RS resource for the UE 102 to identify the receiving (Rx) beam, e.g., quasi co location (QCL)-TypeD (spatial Rx parameter), to receive the configured SSB/CSI-RS resource(s). Then the UE 102 can identify a UE beam to receive the reference SSB/CSI-RS, and the UE 102 can apply the same UE beam to receive the configured SSB/CSI-RS resources for beam measurement and report for co-scheduling UE pairing. As illustrated in FIGS. 4-7 by 407, the UE 102 identifies UE beam to receive the configured SSB/CSI-RS resource(s). The network entity 104 may configure a common reference SSB/CSI-RS resource for all the configured SSB/CSI-RS resources for beam measurement. Alternatively, the network entity 104 may configure a reference SSB/CSI-RS resource per configured SSB/CSI-RS resource for beam measurement.

As illustrated in FIGS. 4-7, the UE 102 identifies UE beam to receive the configured SSB/CSI-RS resource(s). In some implementations, the network entity 104 configures the reference SSB/CSI-RS resource by RRC signaling, i.e., an SSB/CSI-RS resource indicated by an RRC parameter, e.g., qclReference in CSI-ReportConfig. As illustrated in FIGS. 4-7 by 407, the UE 102 identifies UE beam to receive the configured SSB/CSI-RS resource(s).

As illustrated in FIGS. 4-7, the UE 102 identifies UE beam to receive the configured SSB/CSI-RS resource(s). In some other implementations, the network entity 104 indicates the reference SSB/CSI-RS resource by a MAC CE. The MAC CE may include at least one of the parameters: index of serving cell applying for the CSI/beam report configuration, index of bandwidth part applying for the CSI/beam report configuration, CSI/beam report configuration identifier (ID), reference SSB/CSI-RS resource index(es), index of serving cell for the reference SSB/CSI-RS, and index of bandwidth part for the reference SSB/CSI-RS.

As illustrated in FIGS. 4-7, the UE 102 identifies UE beam to receive the configured SSB/CSI-RS resource(s). In some other implementations, the network entity 104 indicates the reference SSB/CSI-RS by a DCI. The DCI may indicate at least one of the parameters: index of serving cell applying for the CSI/beam report configuration, index of bandwidth part applying for the CSI/beam report configuration, CSI/beam report configuration identifier (ID), reference SSB/CSI-RS resource index(es), index of serving cell applying for the reference SSB/CSI-RS, and index of bandwidth part applying for the reference SSB/CSI-RS. In one example, the network entity indicates different configurations by indicating different value of CSI request in DCI.

Referring to FIGS. 4-7, the UE 102 identifies 407 UE beam to receive the configured SSB/CSI-RS resource(s). In an embodiment, the UE 102 reports at least an indicator indicating a reference SSB/CSI-RS resource that the UE 102 used to identify the receiving (Rx) beam, e.g., QCL-TypeD (spatial Rx parameter), to receive the configured SSB/CSI-RS resource(s). In some implementations, the UE 102 reports the reference SSB/CSI-RS resource index in the beam report for co-scheduling UE pairing. In some other implementations, the UE 102 reports the reference SSB/CSI-RS resource index by a separate report, e.g., a beam report for beam selection.

Referring to FIGS. 4-7, the UE 102 identifies 407 UE beam to receive the configured SSB/CSI-RS resource(s). In some implementations, the UE 102 reports a common reference SSB/CSI-RS resource for the reported beam(s) in a beam report for co-scheduling UE pairing. In some other implementations, the UE 102 reports separate reference SSB/CSI-RS resource for each reported beam(s) in a beam report for co-scheduling UE pairing.

Referring to FIGS. 4-7, the UE 102 identifies 407 UE beam to receive the configured SSB/CSI-RS resource(s). In an embodiment, the UE 102 determines the reference SSB/CSI-RS resource used to identify the receiving (Rx) beam, e.g., QCL-TypeD (spatial Rx parameter), based on a predefined rule. In some implementations, the UE 102 selects the SSB/CSI-RS from one of the activated TCI states, e.g., the SSB/CSI-RS in the first or last active TCI state or the SSB/CSI-RS in the active TCI state with lowest or highest TCI state ID. In some implementations, the UE 102 selects the SSB/CSI-RS from one of the configured TCI states, e.g., the SSB/CSI-RS in the first or last configured TCI state or the SSB/CSI-RS in the configured TCI state with lowest or highest TCI state ID. In some other implementations, the UE selects the SSB/CSI-RS in an indicated TCI state, e.g., an indicated TCI state applied to dedicated PDSCH or PUSCH, or the first or last indicated TCI state applied to dedicated PDSCH or PUSCH. In some other implementations, the UE 102 selects the SSB/CSI-RS with strongest L1-RSRP or L1-SINR reported in the most recent beam report or the same beam report. In some implementations, the UE 102 selects the SSB/CSI-RS from the most recent CSI report for L1-RSRP or L1-SINR. In such implementations, the UE could select the first SSB/CSI-RS from the most recent CSI report for L1-RSRP or L1-SINR. In some other implementations, the UE selects the SSB/CSI-RS used for selecting and/or transmitting PRACH or random access (RA) preamble in the most recent RA procedure.

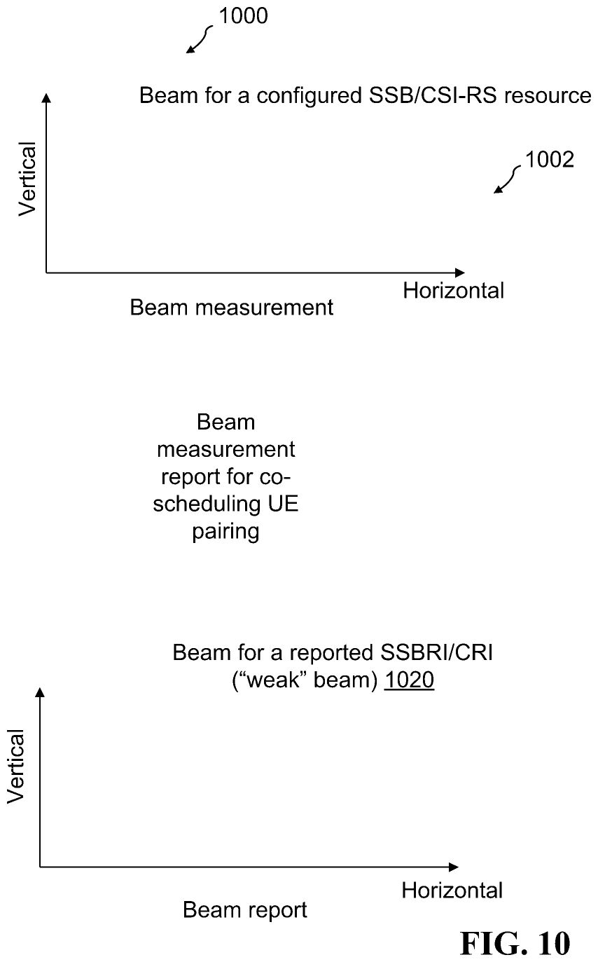

FIG. 10 illustrates an example for the beam report for co-scheduling UE pairing based on the configured SSB/CSI-RS resources. As illustrated by 412, 612 in FIGS. 4-7 and 812 in FIG. 8, the UE transmits a beam report for indicating “weak” beams based on selected SSB/CSI-RS that satisfy the criteria.

In an embodiment, the network entity 104 transmits the first control signaling configuring the UE 102 to report a set of beams 1002 from the configured SSB/CSI-RS resources. The set of beams may be configured based on a grid of vertical and horizontal orientation. In some implementations, the network entity 104 configures an RRC parameter, e.g., type2-beam-report in CSI-ReportConfig, to enable the beam report for co-scheduling UE pairing. The UE 102 identifies a UE beam to receive the configured SSB/CSI-RS resources. The UE 102 measures a beam quality associated with a beam used to transmits the SSB/CSI-RS. The UE 102eports the SSB/CSI-RSs which can satisfy the beam pairing criteria for co-scheduling.

In some implementations, the UE 102 determines an SSB/CSI-RS resource satisfying the beam pairing criteria for co-scheduling if one of or a subset of or all the following conditions are met:

Condition 1: The L1-RSRP measured from the SSB/CSI-RS is below a threshold, where the threshold may be configured by the first control signaling from the network entity or may be predefined or may be reported by the UE. In some implementations, if the threshold is defined based on the transmission power of SSB, the threshold for CSI-RS may be derived based on the threshold for SSB and the transmission power offset between CSI-RS and SSB. For example, if the threshold is defined or configured as X dBm, the threshold for L1-RSRP measured from SSB is X dBm and the threshold for CSI-RS measured from CSI-RS is X-Pc_ss dBm, where Pc_ss indicates the power offset between CSI-RS and SSB. In some other implementations, the threshold is configured/indicated separately for SSB and CSI-RS.

Condition 2: The L1-RSRP measured from the SSB/CSI-RS is below the L1-RSRP measured from a reference SSB/CSI-RS minus a threshold, where the threshold may be configured by the first control signaling from the network entity or may be predefined or may be reported by the UE. The reference SSB/CSI-RS is the one used to derive the UE beam to receive the SSB/CSI-RS. In some implementations, if the threshold is defined based on the transmission power of SSB, the threshold for CSI-RS may be derived based on the threshold for SSB and the transmission power offset between CSI-RS and SSB. For example, if the threshold is defined or configured as X dB, the threshold for L1-RSRP measured from SSB is X dB and the threshold for CSI-RS measured from CSI-RS is X-Pc ss dB, where Pc_ss indicates the power offset between CSI-RS and SSB. In some other implementations, the threshold is configured separately for SSB and CSI-RS.

Condition 3: The coupling loss measured from the SSB/CSI-RS is below a threshold, where the threshold may be configured by the first control signaling from the network entity or may be predefined or may be reported by the UE. The UE calculates the coupling loss based on the L1-RSRP and transmission power for the SSB/CSI-RS.

Condition 4: The coupling loss measured from the SSB/CSI-RS is below the coupling loss measured from a reference SSB/CSI-RS minus a threshold, where the threshold may be configured by the first control signaling from the network entity or may be predefined or may be reported by the UE. The UE calculates the coupling loss based on the L1-RSRP and transmission power for the SSB/CSI-RS. The reference SSB/CSI-RS is the one used to derive the UE beam to receive the SSB/CSI-RS.

In an embodiment, the network entity 104 transmits the first control signaling configuring the UE 102 to report M beams 1020 from the configured SSB/CSI-RS resources, where M is an integer above 0. In some implementations, the UE 102 only reports M SSBRIs/CRIs, where a default or invalid SSBRI/CRI, e.g., SSBRI/CRI=0, may indicate or mean that no qualified beam is identified. Thus, the UE may report M1 (M1<M) valid SSBRIs/CRIs and M-M1 default or invalid SSBRIs/CRIs if the UE is unable to identify M SSBRIs/CRIs that can meet the co-scheduling criteria.

In some other implementations, the UE 102 reports M SSBRIs/CRIs and the L1-RSRP or coupling loss measured from the M SSBRIs/CRIs. The UE may report absolute L1-RSRP or coupling loss for each SSBRIs/CRIs. Alternatively, the UE may report differential L1-RSRP or coupling loss for M-1 SSBRIs/CRIs and absolute L1-RSRP or coupling loss for 1 SSBRI/CRI, which is used to determine the differential L1-RSRP or coupling loss. Alternatively, the UE may report differential L1-RSRP or coupling loss for each SSBRI/CRI with the L1-RSRP or coupling loss for the reference SSB/CSI-RS resource as reference.

In an embodiment, the UE 102 determines and reports the number of reported beams in the beam report for co-scheduling UE pairing. In some implementations, the UE reports a bitmap indicating the beams that can meet the co-scheduling UE pairing criteria. The bitmap may take Y bits, where Y indicates the number of configured SSB/CSI-RS resources for measurement. The first state of bit y may indicate the SSB/CSI-RS resource y can meet the co-scheduling UE pairing criteria, and the second state of bit y may indicate the SSB/CSI-RS resource y cannot meet the co-scheduling UE pairing criteria.

In some other implementations, the UE reports an indicator indicating the number of reported beams and a set of SSBRI(s)/CRI(s) indicating the beam index(es) that can meet the co-scheduling UE pairing criteria. In some other implementations, the UE reports the L1-RSRP or coupling loss for the beams that can meet the co-scheduling UE pairing criteria in addition to the bitmap or SSBRIs/CRIs. The UE may report absolute L1-RSRP or coupling loss for each SSBRIs/CRIs. Alternatively, the UE may report differential L1-RSRP or coupling loss for M-1 SSBRIs/CRIs and absolute L1-RSRP or coupling loss for 1 SSBRI/CRI, which is used to determine the differential L1-RSRP or coupling loss. Alternatively, the UE may report differential L1-RSRP or coupling loss for each SSBRI/CRI with the L1-RSRP or coupling loss for the reference SSB/CSI-RS resource as reference. In some other implementations, if the beam report is transmitted via or in a MAC-CE, a byte or field in the MAC-CE could indicate the number of reported beams in the beam report for co-scheduling UE pairing. The length of the MAC-CE could be dependent on the byte or field.

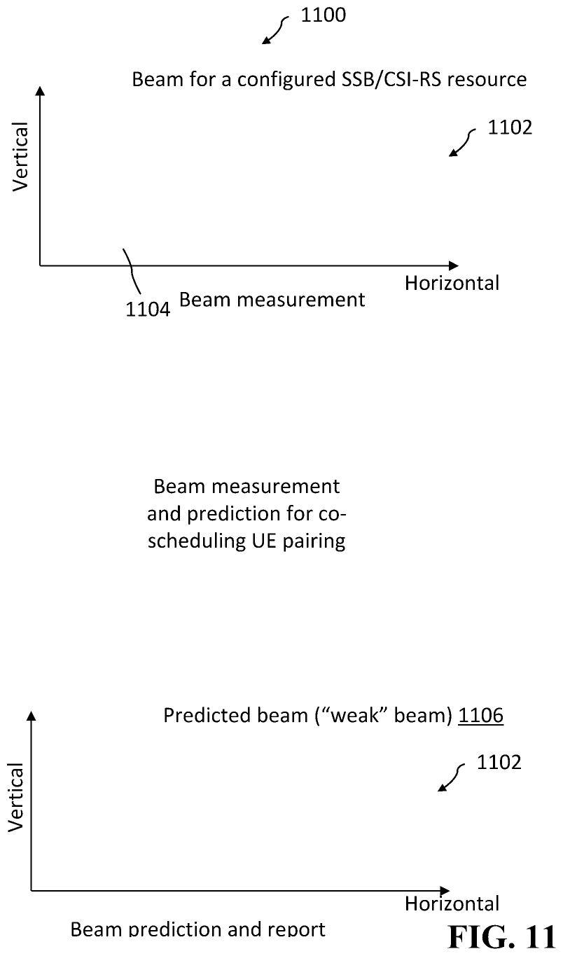

FIG. 11 illustrates an example 1100 for the predicted beam report for co-scheduling UE pairing based on the configured SSB/CSI-RS resources. As illustrated by 512, 712 in FIGS. 4-7 and 812 in FIG. 8, the UE transmits a beam report that indicates predicted “weak” beams. In an embodiment, the network entity 104 transmits the first control signaling configuring the UE 102 to report a set of predicted beams from the configured SSB/CSI-RS resources. In some implementations, the network entity 104 configures an RRC parameter, e.g., type2-beam-prediction in CSI-ReportConfig, to enable the predicted beam report for co-scheduling UE pairing. The network entity 104 may further configure a beam grid 1102, e.g., number of horizontal beams and number of vertical beams for beam prediction in the first control signaling. The network entity may further indicate or configure the location 1104 of the SSB/CSI-RS resource(s) within the beam grid by the first or the second control signaling.

In some implementations, the UE 102 can predict a set of beams 1106 from the configured beam grid 1102 which can satisfy the beam pairing criteria for co-scheduling based on the measurement of the configured SSB/CSI-RS. The UE 102 receives SSB/CSI-RS on the SSB/CSI-Rs resource(s) 1104 and measures a beam quality of beams associated with the SSB/CSI-RS resource(s) and may apply machine learning to these measurements to predict M beams that satisfy the beam pairing criteria for co-scheduling. In one example, the UE 102 may apply machine learning for the “weak” beam prediction. Then the UE can report the beam indexes for the set of beams from the configured beam grid to the network entity.

In an embodiment, the network entity 104 transmits the first control signaling configuring the UE 102 to report M predicted beams 1106 based on the configured SSB/CSI-RS resources, where M is an integer above 0.

In some implementations, the UE 102 only reports M beam indexes from the configured beam grid, where a default or invalid beam index, e.g., beam index=0, may indicate or mean that no qualified beam is identified. Thus, the UE 102 may report M1 (M1<M) valid beam indexes and M-M1 default or invalid beam indexes if the UE 102 is unable to identify M beam indexes that can meet the co-scheduling criteria.

In some other implementations, the UE 102 reports M beam indexes from the configured beam grid and the predicted L1-RSRP or coupling loss measured from the M beams. The UE 102 may report absolute L1-RSRP or coupling loss for each beam. Alternatively, the UE 102 may report differential L1-RSRP or coupling loss for M-1 beams and absolute L1-RSRP or coupling loss for 1 beam, which is used to determine the differential L1-RSRP or coupling loss. Alternatively, the UE 102 may report differential L1-RSRP or coupling loss for each beam with the L1-RSRP or coupling loss for the reference SSB/CSI-RS resource as reference.

In some other implementations, the UE 102 reports M beam indexes from the configured beam grid and the predicted possibility for each reported beam to meet the co-scheduling criteria. In some other implementations, the UE 102 reports M beam indexes from the configured beam grid with the highest predicted possibility to meet the co-scheduling criteria. In some other implementations, the UE 102 reports M beam indexes from the configured beam grid and the reporting order of M beam indexes in the beam report is determined based on their predicted possibility.

In an embodiment, the UE 102 determines and reports the number of reported beams in the beam report for co-scheduling UE pairing. In some implementations, the UE reports a bitmap indicating the beams that can meet the co-scheduling UE pairing criteria. The bitmap may take Y bits, where Y indicates the number of configured beams in beam grid. The first state/value of bit y may indicate the beam y can meet the co-scheduling UE pairing criteria, and the second state/value of bit y may indicate the beam y cannot meet the co-scheduling UE pairing criteria.

In some other implementations, the UE reports an indicator indicating the number of reported beams and a set of beam index(es) from the configured beam grid indicating the beam(s) that can meet the co-scheduling UE pairing criteria. In some other implementations, the UE reports the predicted L1-RSRP or coupling loss or possibility for the beams that can meet the co-scheduling UE pairing criteria in addition to the bitmap or beam index(es). The UE may report absolute L1-RSRP or coupling loss for each beam. Alternatively, the UE may report differential L1-RSRP or coupling loss for M-1 beams and absolute L1-RSRP or coupling loss for 1 beam, which is used to determine the differential L1-RSRP or coupling loss. Alternatively, the UE may report differential L1-RSRP or coupling loss for each beam with the L1-RSRP or coupling loss for the reference SSB/CSI-RS resource as reference. In some other implementations, if the beam report is transmitted via or in a MAC-CE, a byte or field in the MAC-CE could indicate the number of reported beams in the beam report for co-scheduling UE pairing. The length of the MAC-CE could be dependent on the byte or field.

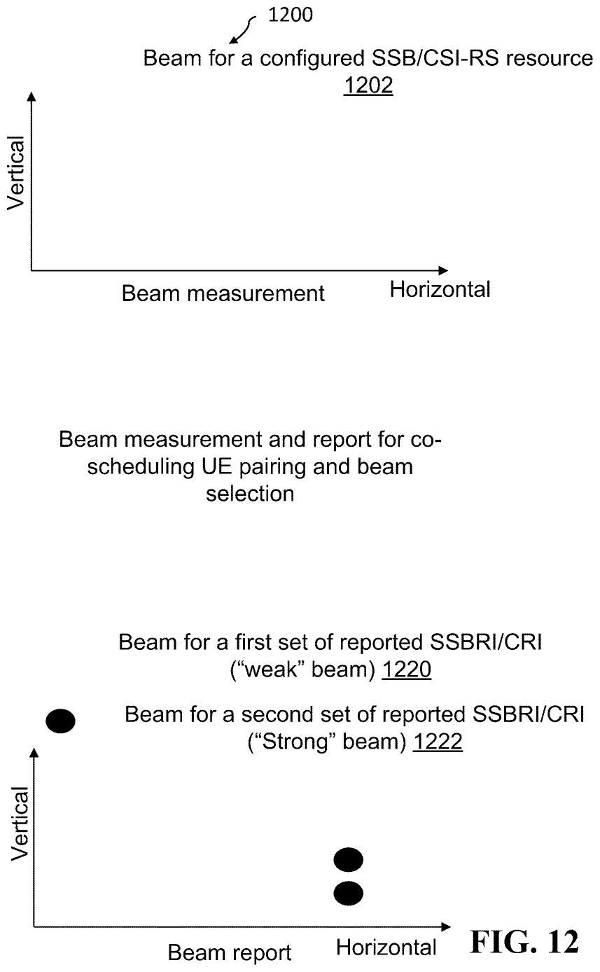

FIG. 12 illustrates an example 1200 for the two sets of beam report for co-scheduling UE pairing and beam selection based on the configured SSB/CSI-RS resources. As illustrated by 412, 612 in FIGS. 4-7 and 812 in FIG. 8, the UE transmits a beam report that indicates a first set of “weak” beams and a second set of “strong” beams based on selected SSB/CSI-RS.

In an embodiment, the network entity 104 transmits the first control signaling configuring the UE 102 to report a first set of beams 1220 from the configured SSB/CSI-RS resources 1202 for co-scheduling UE pairing (“weak” beams) and a second set of beams 1222 from the configured SSB/CSI-RS resources for beam selection/indication (“strong” beam). For example, the first set of beams 1220 are associated with beams satisfying one of the conditions (e.g., conditions 1 to 4 described with reference to FIG. 10). Also, the second set of beams 1222 are associated with beams having the two strongest/largest L1-RSRP or L1-SINR measured form the configured SSB/CSI-RS resource(s).

In some implementations, the network entity configures an RRC parameter, e.g., type2-beam-report in CSI-ReportConfig, to enable the beam report for co-scheduling UE pairing and beam selection. In some other implementations, the network entity configures two RRC parameters indicating number of reported beams for the first set and the second set. In one example, the number of reported beams for the first set could be different from that of the second set. Alternatively, the number of reported beams for the first set and the number of reported beams for the second set could be the same.

For the first set of beams, the UE can identify the number of reported beams and report the status for the selected beams for the first set based on the network configuration or UE selection. The beam report for the first set of beams may be similar to beam report described with reference to FIG. 10.

For the second set of beams, in some implementations, the network entity configures the number of reported beams and the UE reports the SSBRIs/CRIs only for the second set of beams. In some other implementations, the network entity configures the number of reported beams and the report quantity, e.g., L1-RSRP or L1-SINR, and the UE reports the SSBRIs/CRIs and corresponding L1-RSRP or L1-SINR for the second set of beams. In some other implementations, the UE determines the number of reported beams and the UE reports the determined number of beams and SSBRIs/CRIs only for the second set of beams. In some other implementations, the network entity configures the report quantity, e.g., L1-RSRP or L1-SINR, and the UE determines the number of reported beams. The UE reports the determined number of beams and SSBRIs/CRIs and corresponding L1-RSRP or L1-SINR for the second set of beams.

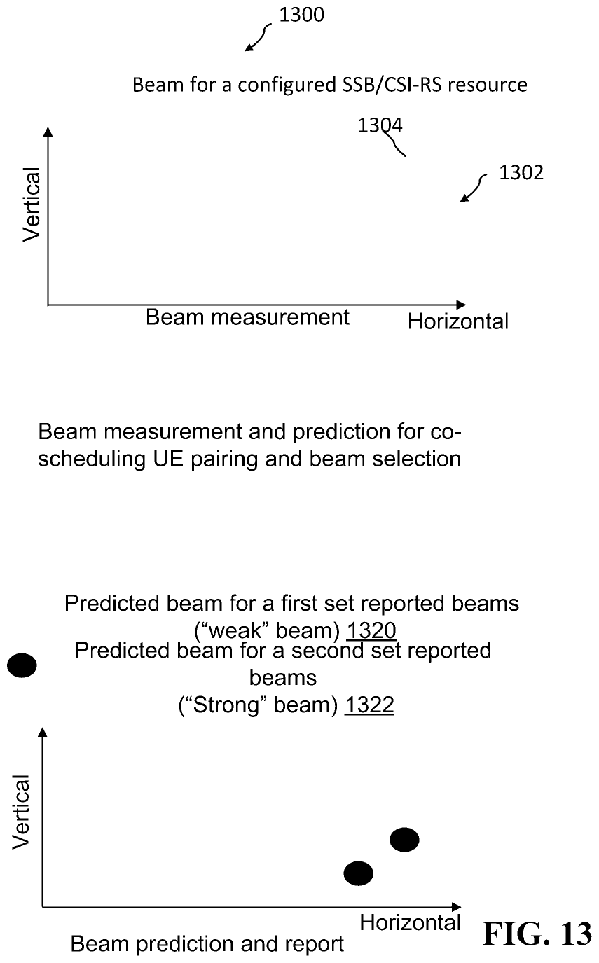

FIG. 13 illustrates an example 1300 for the two sets predicted beam report for co-scheduling UE pairing and beam selection based on the configured SSB/CSI-RS resources. As illustrated by 512, 712 in FIGS. 4-7 and 812 in FIG. 8, the UE transmits a beam report that indicates a first set of predicted “weak” beams and a second set of predicted “strong” beams.

In an embodiment, the network entity 104 transmits the first control signaling configuring the UE 102 to report a first set of predicted beams 1320 based on the configured SSB/CSI-RS resources for co-scheduling UE pairing (“weak” beams) and a second set of predicted beams 1322 based on the configured SSB/CSI-RS resources for beam selection/indication (“strong” beam). In some implementations, the network entity 104 configures an RRC parameter, e.g., type2-beam-report in CSI-ReportConfig, to enable the beam report for co-scheduling UE pairing and beam selection. In some other implementations, the network entity 104 configures two RRC parameters indicating the number of reported beams for the first set 1320 and the second set 1322. In one example, the number of reported beams for the first set 1320 could be different from that of the second set 1322. For example, as illustrated in FIG. 13, the number of the predicted beam for the first set is 4, whereas the number of the predicted beam for the second set is 2. Alternatively, the number of reported beams for the first set and the number of reported beams for the second set could be the same. The network entity 104 may further configure the beam grid 1302, e.g., number of horizontal beams and number of vertical beams for beam prediction in the first control signaling. The network entity 104 may further indicate or configure the location 1304 of the SSB/CSI-RS resource(s) within the beam grid by the first or the second control signaling.

For the first set of beams, the UE 102 can identify the number of reported beams and report the status for the selected beams for the first set based on the network configuration or UE selection.

For the second set of beams, in some implementations, the network entity 104 configures the number of reported beams and the UE 102 reports the beam index(es) only for the second set of beams. In some other implementations, the network entity configures the number of reported beams and the report quantity, e.g., predicted L1-RSRP or L1-SINR or beam prediction accuracy (possibility for the beam to be the best beam), and the UE reports the predicted beams and corresponding predicted L1-RSRP or L1-SINR or beam prediction accuracy for the second set of beams. In some other implementations, the UE determines the number of reported beams and the UE reports the determined number of beams and beam index(es) only for the second set of beams. In some other implementations, the network entity configures the report quantity, e.g., predicted L1-RSRP or L1-SINR or beam prediction accuracy, and the UE determines the number of reported beams. The UE 102 reports the determined number of beams and beam index(es) and corresponding predicted L1-RSRP or L1-SINR or beam prediction accuracy for the second set of beams.

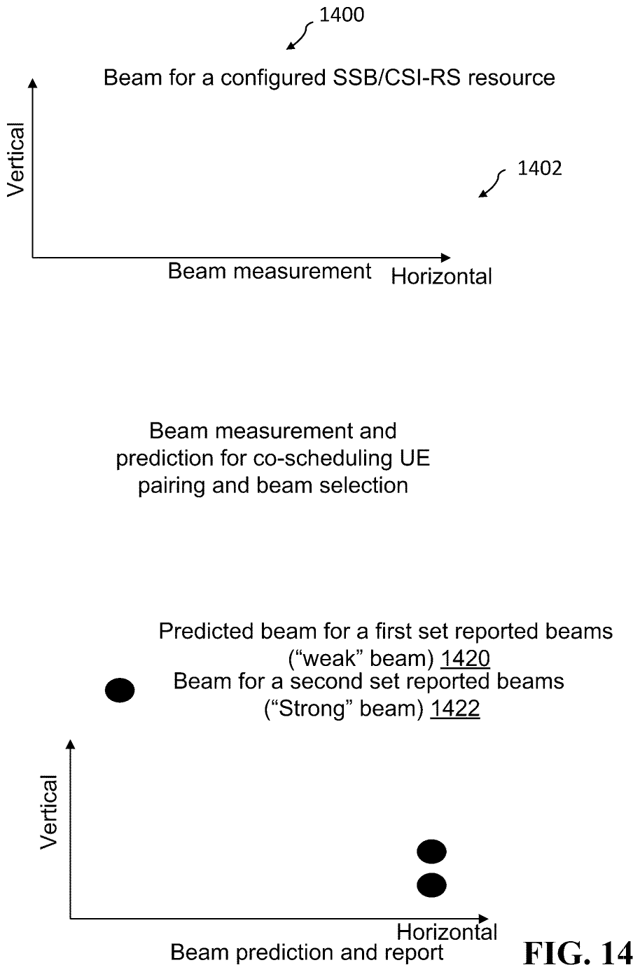

FIG. 14 illustrates an example 1400 for the first set of predicted beam report for co-scheduling UE pairing and the second set of beam report for beam selection based on the configured SSB/CSI-RS resources. As illustrated by 512, 712 in FIGS. 4-7 and 812 in FIG. 8, the UE transmits a beam report that indicates a first set of predicted “weak” beams and a second set of predicted “strong” beams.

In an embodiment, the network entity transmits the first control signaling configuring the UE to report a first set of predicted beams 1420 based on the configured SSB/CSI-RS resources for co-scheduling UE pairing (“weak” beams) and a second set of beams 1422 from the configured SSB/CSI-RS resources for beam selection/indication (“strong” beam). In some implementations, the network entity configures an RRC parameter, e.g., type2-beam-report in CSI-ReportConfig, to enable the beam report for co-scheduling UE pairing and beam selection. In some other implementations, the network entity configures two RRC parameters indicating the number of reported beams for the first set and the second set. The network entity may further configure the beam grid 1402, e.g., number of horizontal beams and number of vertical beams for beam prediction in the first control signaling. The network entity may further indicate or configure the location of the SSB/CSI-RS resource(s) within the beam grid by the first or the second control signaling

For the first set of beams, the UE can identify the number of reported beams and report the status for the selected beams for the first set based on the network configuration or UE selection. The beam report for the first set of beams may be similar to beam report described with reference to FIG. 11.

For the second set of beams, the UE can identify the number of reported beams and report the status for the selected beams for the first set based on the network configuration or UE selection. The beam report for the first set of beams may be similar to beam report described with reference to FIG. 11.

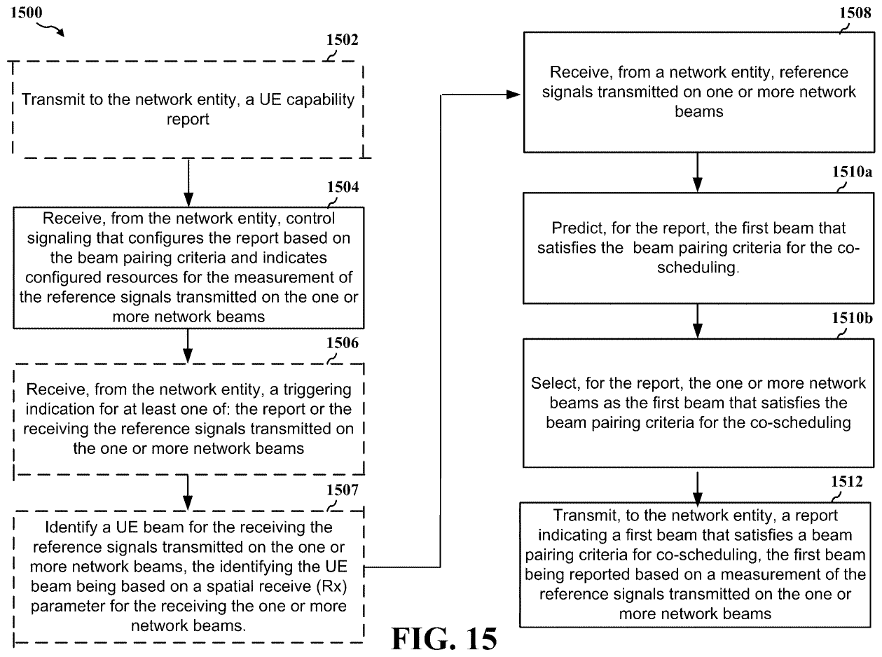

FIG. 15 illustrates a flowchart 1000 of a method of wireless communication at a UE. With reference to FIGS. 1-8 and 17, the method may be performed by the UE 102, the UE apparatus 1702, etc., which may include the memory 1726′, 1706′, 1716, and which may correspond to the entire UE 102 or the entire UE apparatus 1702, or a component of the UE 102 or the UE apparatus 1702, such as the wireless baseband processor 1726 and/or the application processor 1706.

The UE 102 may transmit 1502 to the network entity, a UE capability report. For example, referring to FIG. 4, the UE 102 may transmit 402, to the network entity 104, a UE capability report for supporting a beam report for co-scheduling.

The UE 102 receives 1504, from the network entity 104, control signaling that configures the report based on the beam pairing criteria and indicates configured resources for the measurement of the reference signals transmitted on the one or more network beams. For example, referring to FIG. 4, the UE 102 receives 404, from the network entity 104, a first control signaling, e.g., RRC signaling (RRCReconfiguration), configuring at least one report configuration, e.g., CSI-ReportConfig, associated with at least one synchronization signal block (SSB)/channel state information reference signal (CSI-RS) resource for beam measurement and indicating the report configuration is used for co-scheduled network beam selection.

The UE 102 may receive 1506, from the network entity, a triggering indication for at least one of: the report or the receiving the reference signals transmitted on the one or more network beams. For example, referring to FIG. 4, the UE 102, receives 406, from the network entity 104, a second control signaling triggering the at least one report configuration and/or the at least one SSB/CSI-RS resource.

The UE 102 may identify 1507 a UE beam for the receiving the reference signals transmitted on the one or more network beams, the identifying the UE beam being based on a spatial receive (Rx) parameter for the receiving the one or more network beams. For example, referring to FIG. 4, the UE 102 identifies 407 a UE beam to receive the configured at least one SSB/CSI-RS resource.

The UE 102 receives 1508, from the network entity 104, reference signals transmitted on one or more network beams. For example, referring to FIGS. 4-7, the UE 102 receives 408, from the network entity 104, the configured at least one SSB/CSI-RS resource.

The UE 102 predicts 1510a, for the report, the first beam that satisfies the beam pairing criteria for the co-scheduling. For example, referring to FIG. 5, the UE 102 predicts 510 the co-scheduling beam(s) based on the measured SSB/CSI-RS resources. In one example, the UE 102 may perform the prediction based on machine learning.

The UE 102 selects 1510b, for the report, the one or more network beams as the first beam that satisfies the beam pairing criteria for the co-scheduling. For example, referring to FIG. 4, the UE 102 selects 410 M SSB/CSI-RS resources to report.

The UE 102 transmits 1512, to the network entity 104, a report indicating a first beam that satisfies a beam pairing criteria for co-scheduling, the first beam being reported based on a measurement of the reference signals transmitted on the one or more network beams. For example, referring to FIG. 4, the UE 102 transmits 412, to the network entity 104, indicators (SSBRI/CRI) indicating the beams that can satisfy the beam pairing criteria for co-scheduling. The UE 102 may transmit the beam report via a physical uplink control channel (PUCCH) or a physical uplink shared channel PUSCH. Alternatively, the UE 102 may transmit the beam report via a MAC-CE.

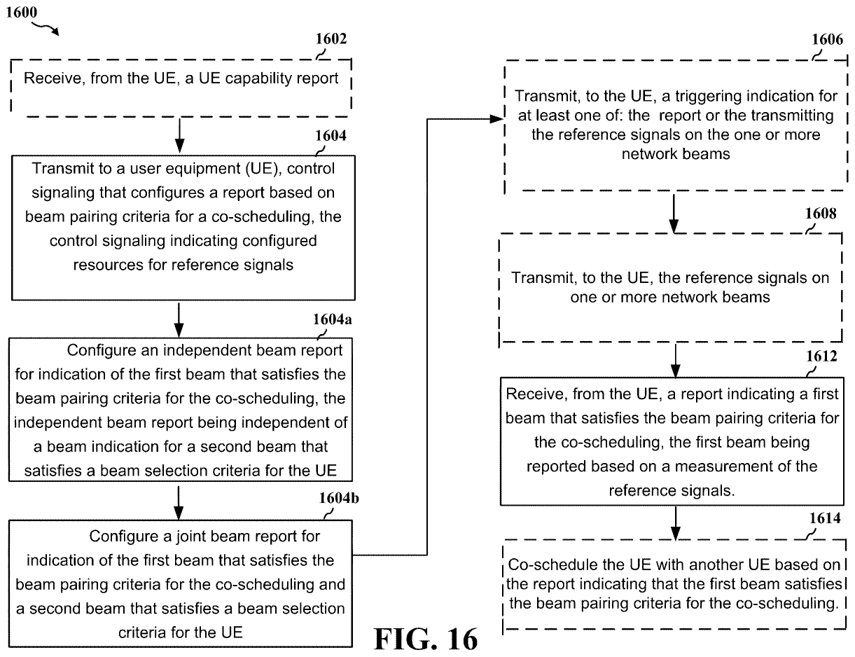

FIG. 15 describes a method from a UE-side of a wireless communication link, whereas FIG. 16 describes a method from a network-side of the wireless communication link.

FIG. 16 is a flowchart 1600 of a method of wireless communication at a network entity. With reference to FIGS. 1-7, 9, and 18, the method may be performed by one or more network entities 104, which may correspond to a base station or a unit of the base station, such as the RU 106, the DU 108, the CU 110, an RU processor 1806, a DU processor 1826, a CU processor 1846, etc. The one or more network entities 104 may include memory 1806′/1826′/1846′, which may correspond to an entirety of the one or more network entities 104, or a component of the one or more network entities 104, such as the RU processor 1806, the DU processor 1826, or the CU processor 1846.

The network entity 104 may receive 1602, from the UE 102, a UE capability report. For example, referring to FIG. 4, network entity 104 receives 402, from the UE 102, a UE capability report for supporting a beam report for co-scheduled network beams.

The network entity 104 transmits 1604 to the UE 102, control signaling that configures a report based on beam pairing criteria for a co-scheduling, the control signaling indicating configured resources for reference signals. For example, referring to FIG. 4, the network entity transmits 404, to the UE 102, a first control signaling, e.g., RRC signaling (RRCReconfiguration), configuring at least one report configuration, e.g., CSI-ReportConfig, associated with at least one SSB/CSI-RS resource for beam measurement and indicating the report configuration is used for co-scheduled network beam selection.

The network entity 104 configures 1604a an independent beam report for indication of the first beam that satisfies the beam pairing criteria for the co-scheduling. The independent beam report is independent of a beam indication for a second beam that satisfies a beam selection criteria for the UE 102. For example, referring to FIG. 4, the network entity transmits 404, to the UE 102, a first control signaling, e.g., RRC signaling (RRCReconfiguration), configuring at least one report configuration, e.g., CSI-ReportConfig, associated with at least one SSB/CSI-RS resource for beam measurement and indicating the report configuration is used for co-scheduled network beam selection.

The network entity 104 configures 1604b a joint beam report for indication of the first beam that satisfies the beam pairing criteria for the co-scheduling and a second beam that satisfies a beam selection criteria for the UE 102. For example, referring to FIG. 4, the network entity transmits 404, to the UE 102, a first control signaling, e.g., RRC signaling (RRCReconfiguration), configuring at least one report configuration, e.g., CSI-ReportConfig, associated with at least one SSB/CSI-RS resource for beam measurement and indicating the report configuration is used for co-scheduled network beam selection.

The network entity 104 may transmit 1606, to the UE 102, a triggering indication for at least one of: the report or the transmitting the reference signals on the one or more network beams. For example, referring to FIG. 4, the UE 102, receives 406, from the network entity 104, a second control signaling triggering the at least one report configuration and/or the at least one SSB/CSI-RS resource.

The network entity 104, may transmit 1608, to the UE 102, the reference signals on one or more network beams. For example, referring to FIG. 4, the network entity 104 transmits 408, to the UE 102, the at least one SSB/CSI-RS resource.

The network entity 104 receives 1612, from the UE 102, a report indicating a first beam that satisfies the beam pairing criteria for the co-scheduling, the first beam being reported based on a measurement of the reference signals. For example, referring to FIG. 4, For example, the network entity 104 receives 412, from the UE 102, a beam report that may include indicators SSB resource indicator/CSI resource indicator (SSBRI/CRI) indicating the beams that can satisfy the beam pairing criteria for co-scheduling

The network entity 104 may co-schedule 1614 the UE 102 with another UE based on the report indicating that the first beam satisfies the beam pairing criteria for the co-scheduling. For example, referring to FIG. 4, the network entity 104 receives 414, from the UE 102, the beam report and identifies the potential co-scheduling UEs pair based on the reported beams.

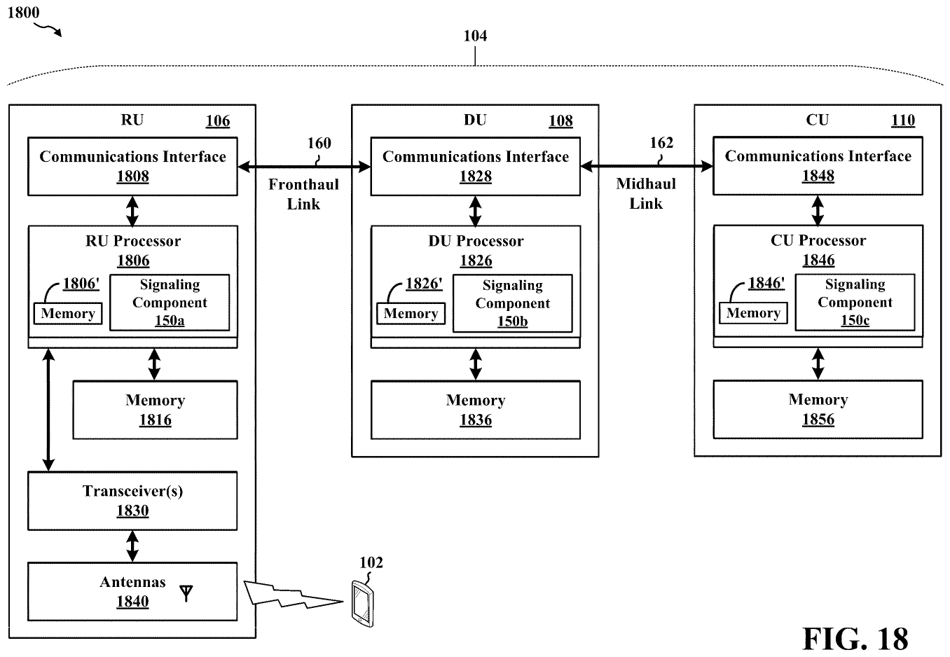

A UE apparatus 1702, as described in FIG. 17, may perform the signaling diagrams of 400, 500, 600, 700 and method of flowchart 800, 1500. The one or more network entities 104, as described in FIG. 18, may perform the signaling diagrams of 400, 500, 600, 700 and the method of flowchart 900, 1600.

FIG. 17 is a diagram 1700 illustrating an example of a hardware implementation for a UE apparatus 1702. The UE apparatus 1702 may be the UE 102, a component of the UE 102, or may implement UE functionality. The UE apparatus 1702 may include an application processor 1706, which may have on-chip memory 1706′. In examples, the application processor 1706 may be coupled to a secure digital (SD) card 1708 and/or a display 1710. The application processor 1706 may also be coupled to a sensor(s) module 1712, a power supply 1714, an additional module of memory 1716, a camera 1718, and/or other related components. For example, the sensor(s) module 1712 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1702 may further include a wireless baseband processor 1726, which may be referred to as a modem. The wireless baseband processor 1726 may have on-chip memory 1726′. Along with, and similar to, the application processor 1706, the wireless baseband processor 1726 may also be coupled to the sensor(s) module 1712, the power supply 1714, the additional module of memory 1716, the camera 1718, and/or other related components. The wireless baseband processor 1726 may be additionally coupled to one or more subscriber identity module (SIM) card(s) 1720 and/or one or more transceivers 1730 (e.g., wireless RF transceivers).

Within the one or more transceivers 1730, the UE apparatus 1702 may include a Bluetooth module 1732, a WLAN module 1734, an SPS module 1736 (e.g., GNSS module), and/or a cellular module 1738. The Bluetooth module 1732, the WLAN module 1734, the SPS module 1736, and the cellular module 1738 may each include an on-chip transceiver (TRX), or in some cases, just a transmitter (TX) or just a receiver (RX). The Bluetooth module 1732, the WLAN module 1734, the SPS module 1736, and the cellular module 1738 may each include dedicated antennas and/or utilize antennas 1740 for communication with one or more other nodes. For example, the UE apparatus 1702 can communicate through the transceiver(s) 1730 via the antennas 1740 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1726 and the application processor 1706 may each include a computer-readable medium/memory 1726′, 1706′, respectively. The additional module of memory 1716 may also be considered a computer-readable medium/memory. Each computer-readable medium/memory 1726′, 1706′, 1716 may be non-transitory. The wireless baseband processor 1726 and the application processor 1706 may each be responsible for general processing, including execution of software stored on the computer-readable medium/memory 1726′, 1706′, 1716. The software, when executed by the wireless baseband processor 1726/application processor 1706, causes the wireless baseband processor 1726/application processor 1706 to perform the various functions described herein. The computer-readable medium/memory may also be used for storing data that is manipulated by the wireless baseband processor 1726/application processor 1706 when executing the software. The wireless baseband processor 1726/application processor 1706 may be a component of the UE 102. The UE apparatus 1702 may be a processor chip (e.g., modem and/or application) and include just the wireless baseband processor 1726 and/or the application processor 1706. In other examples, the UE apparatus 1702 may be the entire UE 102 and include the additional modules of the apparatus 1702.

As discussed, the beam report component 140 is configured to receive, from a network entity, reference signals transmitted on one or more network beams; and transmit to the network entity, a report indicating a first beam that satisfies a beam pairing criteria for co-scheduling, the first beam being reported based on a measurement of the reference signals transmitted on the one or more network beams.

The beam report component 140 may be within the application processor 1706 (e.g., at 140a), the wireless baseband processor 1726 (e.g., at 140b), or both the application processor 1706 and the wireless baseband processor 1726. The beam report component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 18 is a diagram 1800 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1846, which may have on-chip memory 1846′. In some aspects, the CU 110 may further include an additional module of memory 1856 and/or a communications interface 1848, both of which may be coupled to the CU processor 1846. The CU 110 can communicate with the DU 108 through a midhaul link 162, such as an F1 interface between the communications interface 1848 of the CU 110 and a communications interface 1828 of the DU 108.

The DU 108 may include a DU processor 1826, which may have on-chip memory 1826′. In some aspects, the DU 108 may further include an additional module of memory 1836 and/or the communications interface 1828, both of which may be coupled to the DU processor 1826. The DU 108 can communicate with the RU 106 through a fronthaul link 160 between the communications interface 1828 of the DU 108 and a communications interface 1808 of the RU 106.

The RU 106 may include an RU processor 1806, which may have on-chip memory 1806′. In some aspects, the RU 106 may further include an additional module of memory 1816, the communications interface 1808, and one or more transceivers 1830, all of which may be coupled to the RU processor 1806. The RU 106 may further include antennas 1840, which may be coupled to the one or more transceivers 1830, such that the RU 106 can communicate through the one or more transceivers 1830 via the antennas 1840 with the UE 102.

The on-chip memory 1806′, 1826′, 1846′ and the additional modules of memory 1816, 1836, 1856 may each be considered a computer-readable medium/memory. Each computer-readable medium/memory may be non-transitory. Each of the processors 1806, 1826, 1846 is responsible for general processing, including execution of software stored on the computer-readable medium/memory. The software, when executed by the corresponding processor(s) 1806, 1826, 1846 causes the processor(s) 1806, 1826, 1846 to perform the various functions described herein. The computer-readable medium/memory may also be used for storing data that is manipulated by the processor(s) 1806, 1826, 1846 when executing the software. In examples, the signaling component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed, the signaling component 150 is configured to transmit, to a user equipment 102, control signaling that configures a report based on beam pairing criteria for a co-scheduling, the control signaling indicating configured resources for reference signals; transmit, to the UE 102, the reference signals on one or more network beams; and receiving, from the UE 102, a report indicating a first beam that satisfies the beam pairing criteria for the co-scheduling, the first beam being reported based on a measurement of the reference signals.

The signaling component 150 may be within one or more processors of the one or more network entities 104, such as the RU processor 1806 (e.g., at 150a), the DU processor 1826 (e.g., at 150b), and/or the CU processor 1846 (e.g., at 150c). The signaling component 150a-150c may be one or more hardware components specifically configured to carry out the stated processes/algorithm, implemented by one or more processors 1806, 1826, 1846 configured to perform the stated processes/algorithm, stored within a computer-readable medium for implementation by the one or more processors 1806, 1826, 1846, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software_shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving (408), from a network entity (104), reference signals transmitted on one or more network beams; and transmitting (412), to the network entity (104), a report indicating a first beam that satisfies a beam pairing criteria for co-scheduling, the first beam being reported based on a measurement of the reference signals transmitted on the one or more network beams.

Example 2 may be combined with Example 1 and further includes that the one or more network beams satisfies the beam pairing criteria for the co-scheduling, further includes: selecting (410/610), for the report, the one or more network beams as the first beam that satisfies the beam pairing criteria for the co-scheduling.

Example 3 may be combined with Example 1 and further includes that the one or more network beams does not satisfy the beam pairing criteria for the co-scheduling, further includes: predicting (510/710), for the report, the first beam that satisfies the beam pairing criteria for the co-scheduling.

Example 4 may be combined with any of Examples 1-3 and further includes that the report is an independent beam report for indicating, to the network entity (104), the first beam that satisfies the beam pairing criteria for the co-scheduling, the independent beam report being independent of a beam indication for a second beam that satisfies a beam selection criteria for the UE (102).

Example 5 may be combined with any of Examples 1-3 and further includes that the report is a joint beam report for indicating, to the network entity (104), the first beam that satisfies the beam pairing criteria for the co-scheduling and a second beam that satisfies a beam selection criteria for the UE (102).

Example 6 may be combined with any of Examples 1-5 and further includes that the first beam that satisfies the beam pairing criteria for the co-scheduling is associated with a first transmission configuration indicator (TCI) and a second beam that satisfies a beam selection criteria for the UE (102) is associated with a second TCI, the first beam being different from the second beam.

Example 7 may be combined with any of Examples 1-6 and further includes receiving (404), from the network entity (104), control signaling that configures the report based on the beam pairing criteria and indicates configured resources for the measurement of the reference signals transmitted on the one or more network beams.

Example 8 may be combined with any of Examples 1-7 and further includes that the configured resources correspond to at least one of synchronization signal block (SSB) resources or channel state information-reference signal (CSI-RS) resources.

Example 9 may be combined with any of Examples 1-8 and further includes receiving (406), from the network entity (104), a triggering indication for at least one of: the report or the receiving (408) the reference signals transmitted on the one or more network beams.

Example 10 may be combined with any of Examples 1-9 and further includes identifying a UE beam for the receiving the reference signals transmitted on the one or more network beams, the identifying the UE beam being based on a spatial receive (Rx) parameter for the receiving the one or more network beams.

Example 11 may be combined with any of Examples 1-10 and further includes that the report includes (1) an indication of the first beam and (2) a layer 1 reference signal received power (L1-RSRP) measurement of the first beam or a layer 1 signal-to-interference plus noise ratio (L1-SINR) measurement of the first beam.

Example 12 may be combined with any of Examples 1-11 and further includes transmitting (402), to the network entity (104), a UE capability report indicating at least one of: a capability of the UE (102) for the transmitting (412) the report in association with the beam pairing criteria, a first maximum number of configured resources for beam measurements, a second maximum number of reported beams that satisfy the beam pairing criteria, or a minimum number of configured resources for predicting the first beam that satisfies the beam pairing criteria.

Example 13 may be combined with any of Examples 1-12 and further includes that the satisfying the beam pairing criteria for the co-scheduling, includes at least one of: a first L1-RSRP being below a first threshold, a coupling loss being below a second threshold, the first L1-RSRP being below a second L1-RSRP of a reference beam minus a third threshold, or the coupling loss being below the second L1-RSRP of the reference beam minus a fourth threshold.

Example 14 is a method of wireless communication at a network entity, including: transmitting (404), to a user equipment (UE) (102), control signaling that configures a report based on beam pairing criteria for a co-scheduling, the control signaling indicating configured resources for reference signals; transmitting (408), to the UE (102), the reference signals on one or more network beams; and receiving (412), from the UE (102), a report indicating a first beam that satisfies the beam pairing criteria for the co-scheduling, the first beam being reported based on a measurement of the reference signals.

Example 15 may be combined with Example 14 and further includes co-scheduling the UE with another UE based on the report indicating that the first beam satisfies the beam pairing criteria for the co-scheduling.

Example 16 may be combined with any of Examples 14-15 and further includes that the first beam that satisfies the beam pairing criteria is the one or more network beams transmitted to the UE (102) on the configured resources.

Example 17 may be combined with any of Examples 14-15 and further includes that the first beam that satisfies the beam pairing criteria is a different beam from the one or more network beams transmitted to the UE (102) on the configured resources.

Example 18 may be combined with any of Examples 14-17 and further includes that the control signaling that configures the report, further includes configuring (404) an independent beam report for indication of the first beam that satisfies the beam pairing criteria for the co-scheduling, the independent beam report being independent of a beam indication for a second beam that satisfies a beam selection criteria for the UE (102).

Example 19 may be combined with any of Examples 14-17 and further includes that the control signaling that configures the report, further includes configuring (404) a joint beam report for indication of the first beam that satisfies the beam pairing criteria for the co-scheduling and a second beam that satisfies a beam selection criteria for the UE (102).

Example 20 may be combined with any of Examples 14-19 and further includes that the first beam that satisfies the beam pairing criteria for the co-scheduling is associated with a first transmission configuration indicator (TCI) and a second beam that satisfies the beam selection criteria for the UE (102) is associated with a second TCI, the first beam being different from the second beam.

Example 21 may be combined with any of Examples 14-20 and further includes that the configured resources correspond to at least one of synchronization signal block (SSB) resources or channel state information-reference signal (CSI-RS) resources.

Example 22 may be combined with any of Examples 14-21 and further includes transmitting (406), to the UE (102), a triggering indication for at least one of: the report or the transmitting the reference signals on the one or more network beams.

Example 23 may be combined with any of Examples 14-22 and further includes receiving (402), from the UE (102), a UE capability report indicating at least one of: a capability of the UE (UE) for the receiving the report in association with the beam pairing criteria, a first maximum number of configured resources for beam measurements, a second maximum number of reported beams that satisfy the beam pairing criteria, or a minimum number of configured resources for predicting the beam that satisfies the beam pairing criteria.

Example 24 may be combined with any of Examples 14-23 and further includes that the satisfying the beam pairing criteria for the co-scheduling, includes: a layer 1 reference signal received power (L1-RSRP) being below a first threshold, a coupling loss being below a second threshold, the L1-RSRP being below a second L1-RSRP of a reference beam minus a third threshold, or the coupling loss being below the second L1-RSRP of the reference beam minus a fourth threshold.

Example 25 is an apparatus for wireless communication for implementing a method as in any of Examples 1-24.

Example 26 is an apparatus for wireless communication including means for implementing a method as in any of Examples 1-24.

Example 27 is a non-transitory computer-readable medium storing computer executable code, the code when executed by a processor causes the processor to implement a method as in any of Examples 1-24.

1. A method of wireless communication at a user equipment, comprising:
receiving, from a network entity, reference signals transmitted on one or more network beams; and
transmitting, to the network entity, a report indicating a first beam that satisfies a beam pairing criteria for co-scheduling, the first beam being reported based on a measurement of the reference signals transmitted on the one or more network beams, the satisfying of the beam pairing criteria includes a layer 1 reference signal received power, L1-RSRP, measurement of the first beam being below a first threshold.

2. The method of claim 1, wherein the one or more network beams satisfies the beam pairing criteria for the co-scheduling, further comprising:
selecting, for the report, the one or more network beams as the first beam that satisfies the beam pairing criteria for the co-scheduling.

3. The method of claim 1, wherein the one or more network beams does not satisfy the beam pairing criteria for the co-scheduling, further comprising:
predicting, for the report, the first beam that satisfies the beam pairing criteria for the co-scheduling.

4. The method of claim 1, wherein the report is an independent beam report for indicating, to the network entity, the first beam that satisfies the beam pairing criteria for the co-scheduling, the independent beam report being independent of a beam indication for a second beam that satisfies a beam selection criteria for the UE.

5. The method of claim 1, wherein the report is a joint beam report for indicating, to the network entity, the first beam that satisfies the -beam pairing criteria for the co-scheduling and a second beam that satisfies a beam selection criteria for the UE.

6. The method of claim 1, wherein the first beam that satisfies the beam pairing criteria for the co-scheduling is associated with a first transmission configuration indicator and a second beam that satisfies a beam selection criteria for the UE is associated with a second TCI, the first beam being different from the second beam.

7. The method of claim 1, further comprising:
receiving, from the network entity, control signaling that configures a number of beams to be reported in the report based on the beam pairing criteria and indicates configured resources for the measurement of the reference signals transmitted on the one or more network beams.

8. The method of claim 7, wherein the configured resources correspond to at least one of synchronization signal block resources or channel state information-reference signal resources.

9. The method of claim 1, further comprising:
receiving, from the network entity, a triggering indication for at least one of: the report or the receiving the reference signals transmitted on the one or more network beams.

10. The method of claim 1: further comprising:
identifying a UE beam for the receiving the reference signals transmitted on the one or more network beams, the identifying the UE beam being based on a spatial receive parameter for the receiving the one or more network beams.

11. The method of claim 1, wherein the report includes (1) an indication of the first beam and (2) a (L1-RSRP) measurement of the first beam or a layer 1 signal-to-interference plus noise ratio (L1-SINR) measurement of the first beam.

12. The method of claim 1, further comprising:
transmitting, to the network entity, a UE capability report indicating at least one of:
a capability of the UE for the transmitting the report in association with the beam pairing criteria,
a first maximum number of configured resources for beam measurements,
a second maximum number of reported beams that satisfy the beam pairing criteria, or
a minimum number of configured resources for predicting the first beam that satisfies the beam pairing criteria.

13. The method of claim 1, wherein satisfying the beam pairing criteria for the co-scheduling, comprises at least one of:
a coupling loss being below a second threshold,
the first L1-RSRP being below a second L1-RSRP of a reference beam minus a third threshold, or
the coupling loss being below the second L1-RSRP of the reference beam minus a fourth threshold.

14. A method of wireless communication at a network entity, comprising:
transmitting, to a user equipment, reference signals on one or more network beams; and
receiving, from the UE, a report indicating a first beam that satisfies the -beam pairing criteria for a co-scheduling, the first beam being reported based on a measurement of the reference signals.

15. The method of claim 14, further comprising:
transmitting, to the UE, control signaling that configures a number of beams to be reported in the report based on the beam pairing criteria and indicates configured resources for the measurement of the reference signals transmitted on the one or more network beams; and
co-scheduling the UE with another UE based on the report indicating that the first beam satisfies the beam pairing criteria for the co-scheduling.

16. An apparatus for wireless communication at a user equipment, comprising:
a transceiver;
a memory; and
a processor coupled to the memory and the transceiver, the processor configured to:
receive, from a network entity, reference signals transmitted on one or more network beams; and
transmit, to the network entity, a report indicating a first beam that satisfies a beam pairing criteria for co-scheduling, the first beam being reported based on a measurement of the reference signals transmitted on the one or more network beams, the satisfying of the beam pairing criteria includes a layer 1 reference signal received power (L1-RSRP) measurement of the first beam being below a first threshold.

17. The apparatus of claim 16, wherein the one or more network beams does not satisfy the beam pairing criteria for the co-scheduling, and wherein the processor is further configured to:
predict, for the report, the first beam that satisfies the beam pairing criteria for the co-scheduling.

18. The apparatus of claim 16, wherein the report is an independent beam report for indicating, to the network entity, the first beam that satisfies the beam pairing criteria for the co-scheduling, the independent beam report being independent of a beam indication for a second beam that satisfies a beam selection criteria for the UE.

19. The apparatus of claim 16, wherein the report is a joint beam report for indicating, to the network entity, the first beam that satisfies the beam pairing criteria for the co-scheduling and a second beam that satisfies a beam selection criteria for the UE.

20. The apparatus of claim 16, wherein the processor is further configured to:
receive, from the network entity, a triggering indication for at least one of: the report or the receiving the reference signals transmitted on the one or more network beams.
